(19) United States
(12) Patent Application Publication
(10) Pub. No.: US 2005/0048966 A1
(43) Pub. Date: Mar. 3, 2005

(54) Enhanced IS-2000 mobile capabilities information element

(75) Inventor: William J. Semper, Richardson, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 10/880,900

(22) Filed: Jun. 30, 2004

Related U.S. Application Data
(60) Provisional application No. 60/498,068, filed on Aug. 26, 2003.

(51) Int. Cl. H04Q 7/20

(52) U.S. Cl. 455/425; 455/423

(57) ABSTRACT

A signal for use in a wireless network indicates capabilities of a mobile station within the wireless network. The signal includes at least one supported bit indicating the mobile station capabilities and at least one support included bit indicating whether the at least one supported bit is valid.

### CROSS-REFERENCE TO RELATED APPLICATION AND CLAIM OF PRIORITY

The present invention is related to that disclosed in U.S. Provisional Patent Application Ser. No. 60/498,068, filed Aug. 26, 2003, entitled “Support Included Bit”. U.S. Provisional Patent Application Ser. No. 60/498,068 is assigned to the assignee of the present application. The subject matter disclosed in U.S. Provisional Patent Application Ser. No. 60/498,068 is hereby incorporated by reference into the present disclosure as if fully set forth herein. The present invention hereby claims priority under 35 U.S.C. §119(e) to U.S. Provisional Patent Application Ser. No. 60/498,068.

### TECHNICAL FIELD OF THE INVENTION

The present invention is directed, in general, to wireless networks and, more specifically, to CDMA2000 wireless network mobile switching centers and base stations that use an IS-2000 Mobile Capabilities information Element.

### BACKGROUND OF THE INVENTION

In current Inter-Operability Standard (IOS) signaling in code division multiple access (CDMA) wireless networks, the Mobile Switching Center (MSC) is capable of alerting the Base Station (BS) of capabilities supported by a Mobile Station (MS). For example, when the MSC asks the BS to page the MS, the MSC can provide information to the BS indicating the type of traffic channels the MS supports to assist the BS in setting up traffic channels for the MS. The mobile station capabilities are included in “supported bits” in the IOS signaling. Each “supported bit” indicates whether or not the MS supports a particular feature.

Currently, the MSC uses the IS-2000 Mobile Capabilities information element to convey the MS's capabilities to the BS. This information element contains six bits, each of which indicates a specific mobile capability (e.g., support for the Fundamental Channel, support for the Dedicated Control Channel, etc.). For each bit, “0” indicates that the MS does not support this capability, and “1” indicates that the MS does support this capability. The IS-2000 Mobile Capabilities information element is used in a number of different messages sent from the MSC to the BS.

In addition, the IS-2000 Mobile Capabilities information element can also be used in a number of different messages sent from the BS to the MSC to indicate MS capabilities to the MSC. For example, when the BS receives an Origination Message from the MS, the BS can indicate the features the MS supports to the MSC in the IS-2000 Mobile Capabilities information element.

Unfortunately, in the current state of the art, the sending telecommunications node (MSC or BS) does not always have the mobile station capabilities information at the time of sending a message to the receiving telecommunications node (MSC or BS) Since each bit is set to only one of two possible values (“0” or “1”), the sending telecommunications node is unable to indicate to the receiving telecommunications node whether or not the “supported bits” are valid.

As a result, the current state of the art can lead to confusion in IOS deployments, because the receiving telecommunications node is unable to determine whether or not the supported bits contain valid information. Unless an inter-vendor agreement is reached outside of the standard, ensuring that the bits either do or do not always carry valid information, the supported bits in the IS-2000 Mobile Capabilities information element become useless.

Therefore, there is a need in the art for improved wireless networks and improved wireless mobile switching centers and wireless base stations that use the IS-2000 Mobile Capabilities information element. In particular, there is a need for CDMA2000 wireless network base stations and wireless network mobile switching centers that use an enhanced IS-2000 Mobile Capabilities information element to indicate if the supported bits contain valid information.

### SUMMARY OF THE INVENTION

The present invention adds a support included bit to the IS-2000 Mobile Capabilities information element that indicates whether the supported bits contain valid information. Thus, when the MSC or BS sends a message to the other including the IS-2000 Mobile Capabilities information element, the receiving telecommunications node will be able to determine whether the mobile station (MS) capabilities included in the information element are valid.

To address the above-discussed deficiencies of the prior art, it is a primary object of the present invention to provide, for use in a wireless network, a signal for indicating capabilities of a mobile station within the wireless network. According to an advantageous embodiment of the present invention, the signal comprises: (i) at least one supported bit indicating the capabilities; and (ii) at least one support included bit indicating whether the at least one supported bit is valid.

According to one embodiment of the present invention, the signal is sent from a sending telecommunications node to a receiving telecommunications node, where the receiving telecommunications node is capable of verifying the validity of the capabilities of the mobile station from the signal.

According to another embodiment of the present invention, the signal is sent from a sending telecommunications node to a receiving telecommunications node, where the sending telecommunications node is capable of verifying the validity of the capabilities of the mobile station and including the support included bit in the signal.

According to still another embodiment of the present invention, the signal comprises an IS-2000 Mobile Capabilities information element.

According to a further embodiment of the present invention, the at least one support included bit indicates whether all of the supported bits are valid.

According to a still further embodiment of the present invention, the at least one support included bit comprises a respective support included bit for each of the supported bits.

According to yet another embodiment of the present invention, the receiving telecommunications node is a base station.

According to yet a further embodiment of the present invention, the receiving telecommunications node is a mobile switching center.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network, which uses an enhanced IS-2000 Mobile Capabilities information element according to the principles of the present invention;

FIG. 2 illustrates an enhanced IS-2000 Mobile Capabilities information element according to the principles of the present invention; and

FIG. 3 illustrates a message incorporating the enhanced IS-2000 Mobile Capabilities information element according to the principles of the present invention.

### DETAILED DESCRIPTION OF THE INVENTION

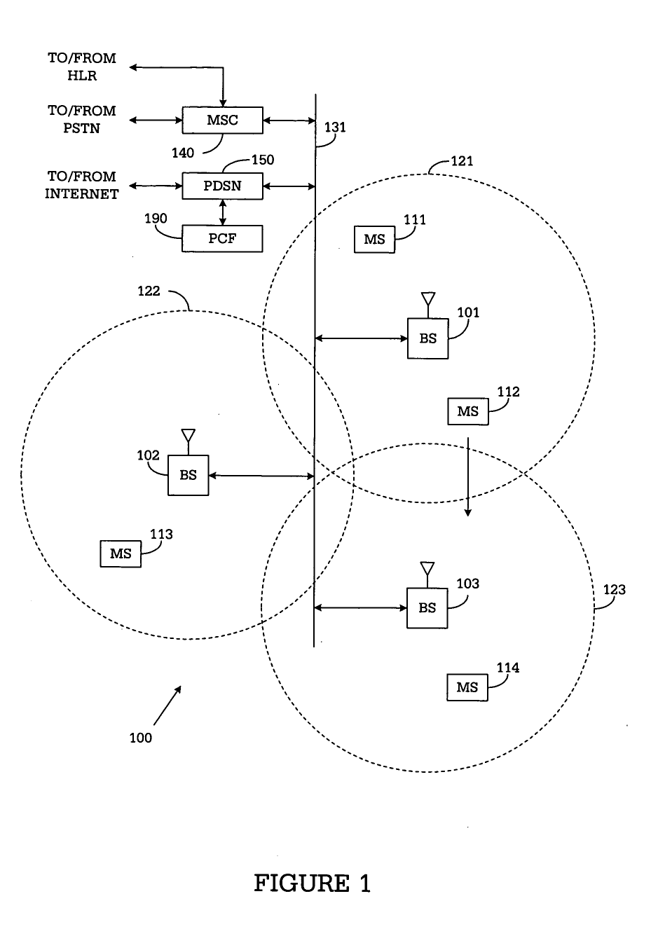

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

FIG. 1 illustrates exemplary wireless network 100, which uses an enhanced IS-2000 Mobile Capabilities information Element according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to the IS-2000-C standard (i.e., Release C of cdma2000) Mobile stations 111-114 may be any suitable wireless devices, including conventional cellular radiotelephones, PCS handset devices, personal digital assistants, portable computers, telemetry devices, and the like, which are capable of communicating with the base stations via wireless links. In one preferred embodiment of the present invention, mobile stations 111-114 communicate with base stations 101-103 to provide mobile capabilities information to base stations 101-103 for inclusion in an enhanced IS-2000 Mobile Capabilities information element, as discussed in more detail below.

It should be understood that the present invention is not limited to mobile devices. Other types of wireless access terminals, including fixed wireless terminals, may be used. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., monitoring devices with wireless capability).

Dotted lines show the approximate boundaries of the cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, cell sites 121-123 are comprised of a plurality of sectors (not shown), where a directional antenna coupled to the base station illuminates each sector. The embodiment of FIG. 1 illustrates the base station in the center of the cell. Alternate embodiments position the directional antennas in corners of the sectors. The system of the present invention is not limited to any particular cell site configuration.

In one embodiment of the present invention, BS 101, BS 102, and BS 103 comprise a base station controller (BSC) and at least one base transceiver subsystem (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystem in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of base stations 101-103, or as a stand-alone device that communicates with PDSN 150, as shown in FIG. 1. Line 131 also provides the connection path to transfer control signals between MSC 140 and BS 101, BS 102 and BS 103 used to establish connections for voice and data circuits between MSC 140 and BS 101, BS 102 and BS 103.

Communication line 131 may be any suitable connection means, including a T1 line, a T3 line, a fiber optic link, or any other type of data connection. The connections on line 131 may transmit analog voice signals or digital voice signals in pulse code modulated (PCM) format, Internet Protocol (IP) format, asynchronous transfer mode (ATM) format, or the like. According to an advantageous embodiment of the present invention, a portion of communication line 131 between BS 101, BS 102 and BS 103 and MSC 140 forms an A1 interface for transmitting signals, such as a message including an enhanced IS-2000 Mobile Capabilities information element, between MSC 140 and BS's 101, 102 and 103.

MSC 140 is a switching device that provides services and coordination between the subscribers in a wireless network and external networks, such as the PSTN or Internet. MSC 140 communicates with a Home Location Register (HLR) to update and retrieve subscriber data associated with subscribers located in wireless network 100. For example, MSC 140 can communicate with HLR to retrieve mobile capabilities information for inclusion in an enhanced IS-2000 Mobile Capabilities information element according to the principles of the present invention. MSC 140 is well known to those skilled in the art. In some embodiments of the present invention, communications line 131 may be several different data links where each data link couples one of BS 101, BS 102 or BS 103 to MSC 140.

In the embodiment of wireless network 100 shown in FIG. 1, MS 111 and MS 112 are located in cell site 121 and communicate with BS 101. MS 113 is located in cell site 122 and communicates with BS 102 and MS 114 is located in cell site 123 and communicates with BS 103. MS 112 is located close to the edge of cell site 123 and moves in the direction of cell site 123, as indicated by the direction arrow proximate MS 112. At some point, as MS 112 moves into cell site 123 and out of cell site 121, a handoff will occur.

As is well known to those skilled in the art, the handoff procedure transfers control of a call from a first cell to a second cell. A handoff may be either a “soft” handoff or a “hard” handoff. In a soft handoff, a connection is made between the mobile station and the base station in the second cell before the existing connection is broken between the mobile station and the base station in the first cell. In a hard handoff, the existing connection between the mobile station and the base station in the first cell is broken before a new connection is made between the mobile station and the base station in the second cell.

As MS 112 moves from cell 121 to cell 123, MS 112 detects the pilot signal from BS 103 and sends a Pilot Strength Measurement Message to BS 101. When the strength of the pilot transmitted by BS 103 and received and reported by MS 112 exceeds a threshold, BS 101 initiates a soft handoff process by signaling the target BS 103 that a handoff is required as described in TIA/EIA IS-95 or TIA/EIA IS-2000.

BS 103 and MS 112 proceed to negotiate establishment of a communications link in the CDMA channel. Following establishment of the communications link between BS 103 and MS 112, MS 112 communicates with both BS 101 and BS 103 in a soft handoff mode. Those acquainted with the art will recognize that soft hand-off improves the performance on both forward (BS to MS) channel and reverse (MS to BS) channel links. When the signal from BS 101 falls below a predetermined signal strength threshold, MS 112 may then drop the link with BS 101 and only receive signals from BS 103. The call is thereby seamlessly transferred from BS 101 to BS 103. The above-described soft handoff assumes the mobile station is in a voice or data call. An idle handoff is the hand-off between cell sites of a mobile station that is communicating in the control or paging channel.

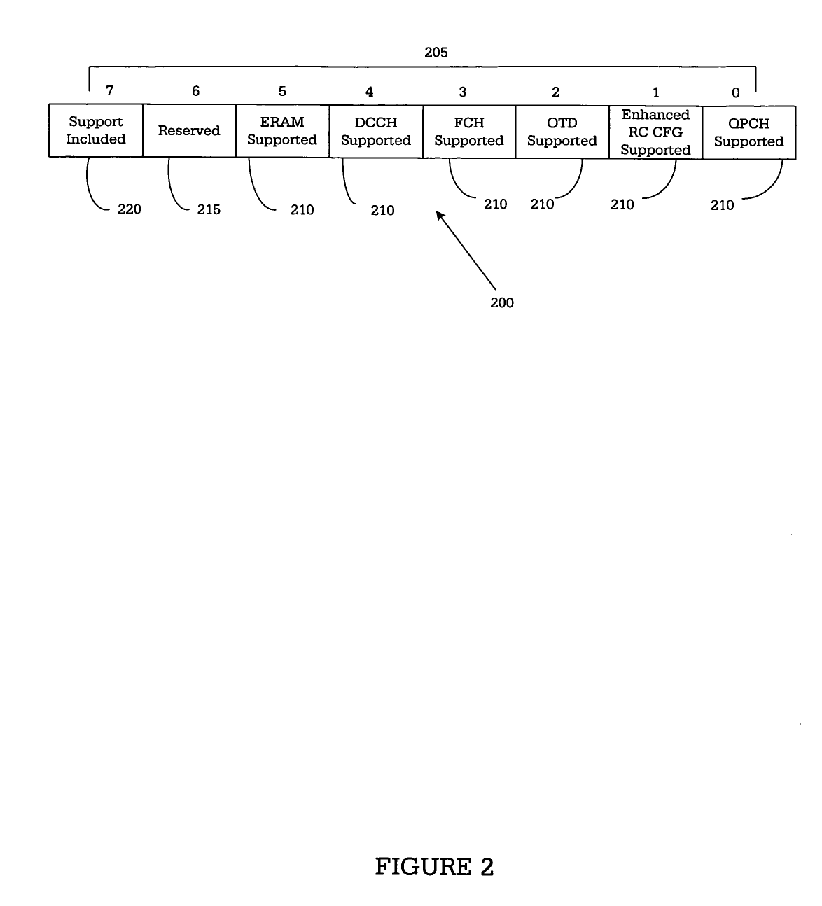

To verify the validity of identified mobile station capabilities, wireless network 100 and the telecommunications nodes (MSC and BS) within wireless network 100 implement an enhanced IS-2000 Mobile Capabilities information element according to the principles of the present invention. FIG. 2 illustrates an enhanced IS-2000 Mobile Capabilities information element 200 according to one embodiment of the present invention. Enhanced IS-2000 Mobile Capabilities information element 200 comprises a plurality of octets 205 (only one of which is shown for simplicity), each including eight bits 210. Each octet 205 provides information about the mobile station capabilities. For example, the octet 205 shown in FIG. 2 includes six “supported” bits 210, each of which indicate a whether or not the mobile station supports a specific feature.

Bit 0 is a Quick Paging Channel (QPCH) Supported bit 210 that indicates whether or not the mobile station supports the IS-2000 Quick Paging Channel. A value of “1” indicates the mobile station supports the QPCH, while a value of “0” indicates the mobile station does not support the QPCH. Bit 1 is an Enhanced RC CFG Supported bit 210 that indicates whether or not the mobile station supports any radio configuration in class 2. A value of “1” indicates the mobile station supports the configuration, while a value of “0” indicates the mobile station does not support the configuration.

Bit 2 is an Orthogonal Transmit Diversity (OTD) Supported bit 210 that indicates whether or not the mobile station supports OTD. A value of “1” indicates the mobile station supports OTD, while a value of “0” indicates the mobile station does not support OTD. Bit 3 is a Fundamental Channel (FCH) Supported bit 210 that indicates whether or not the mobile station supports the IS-2000 FCH. A value of “1” indicates the mobile station supports the FCD, while a value of “0” indicates the mobile station does not support the FCH.

Bit 4 is a Dedicated Control Channel (DCCH) Supported bit 210 that indicates whether or not the mobile station supports the IS-2000 DCCH. A value of “1” indicates the mobile station supports the DCCH, while a value of “0” indicates the mobile station does not support the DCCH. Bit 5 is an Enhanced Rate Adaptation Mode (ERAM) Supported bit 210 that indicates whether or not the mobile station supports the ERAM. A value of “1” indicates the mobile station supports the ERAM, while a value of “0” indicates the mobile station does not support the ERAM. Bit 6 is shown as a reserved bit 215.

In accordance with the principles of the present invention, bit 7 is a Support Included bit 220 that indicates to the receiving telecommunications node (i.e., either the BS or the MSC) whether or not the supported bits 210 (bits 0-6) contain valid information. The Support Included Bit 220 is set by the sending telecommunications node upon verification of the validity of the mobile station capabilities information. A value of “0” indicates that the supported bits 210 do not contain valid information, while a value of “1” indicates that the supported bits 210 do contain valid information.

In another embodiment, multiple Support Included bits 220 can be provided for each of the six supported bits 210, thereby allowing only a portion of the supported bits 210 to contain valid information. For example, although not shown in FIG. 2, an additional octet can be included in the IS-2000 Mobile Capabilities information element with an individual Support Included bit 220 for each of the six supported bits 210.

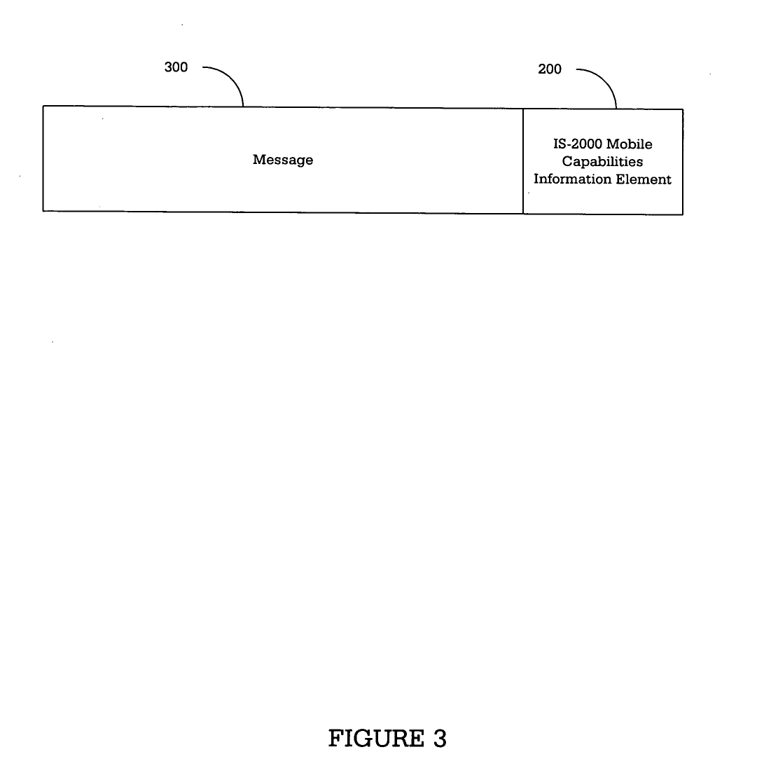

FIG. 3 illustrates a message 300 incorporating the enhanced IS-2000 Mobile Capabilities information element 200 according to the principles of the present invention. Message 300 can be sent from MSC 140 to a BS (e.g., BS 101) or message 300 can be sent from BS 101 to MSC 140. For example, the enhanced IS-2000 Mobile Capabilities information element 200 can be included within a Connection Management (CM) Service Request message 300 transferred by BS 101 to MSC 140 to initiate an MS originated call setup scenario or a Paging Request message 300 sent from MSC 140 to BS 101 to initiate an MS terminated call setup scenario.

In addition, the enhanced IS-2000 Mobile Capabilities information element 200 can be included within a Paging Response message 300 sent from BS 101 to MSC 140 after receipt of a Page Response message from an MS (e.g., MS 111), in response to a Paging Request message. The enhanced IS-2000 Mobile Capabilities information element 200 can also be included within a Feature Notification message 300 sent by MSC 140 to BS 101 to initiate sending of the feature indication information to MS 111 or an Authentication Request message 300 sent from MSC 140 to BS 101 to initiate an authentication check on MS 111. Furthermore, the enhanced IS-2000 Mobile Capabilities information element 200 can be included within a Location Updating message 300 sent by BS 101 to MSC 140 to request an update to the MS's 111 location area when the MS 111 moves to a new location from its previous location, a Handoff Required message 300 sent from BS 101 to MSC 140 to initiate a handoff or a Handoff Request message 300 sent from MSC 140 to BS 101 to request BS 101 to provide radio resources for a handoff.

Additionally, the enhanced IS-2000 Mobile Capabilities information element 200 can be included within a Status Request message 300 sent from MSC 140 to BS 101 to request certain information from MS 111, such as call mode, terminal information, roaming information, security status, etc., an Application Data Delivery Service (ADDS) Page message 300 sent from MSC 140 to BS 101 to transport an application data message or a User Zone Reject message 300 sent from MSC 140 to BS 101 to indicate that a request for a change of User Zone was rejected. It should be understood that the enhanced IS-2000 Mobile Capabilities information element 200 can be included within any message 300 sent between MSC 140 and BS 101, and is not limited to the messages discussed herein.

Although the present invention has been described with an exemplary embodiment, various changes and modifications may be suggested to one skilled in the art. It is intended that the present invention encompass such changes and modifications as fall within the scope of the appended claims.

1. For use in a wireless network, a receiving telecommunications node for receiving from a sending telecommunications node a signal including capabilities of a mobile station served by said receiving telecommunications node, wherein said receiving telecommunications node is capable of verifying the validity of said capabilities of said mobile station from said signal.

2. The receiving telecommunications node as set forth in claim 1 wherein said signal comprises an information element including said capabilities.

3. The receiving telecommunications node as set forth in claim 2 wherein said information element further includes a valid indication indicating whether said capabilities are valid.

4. The receiving telecommunications node as set forth in claim 3 wherein said information element is an IS-2000 Mobile Capabilities information element.

5. The receiving telecommunications node as set forth in claim 3 wherein said information element includes a plurality of supported bits containing said capabilities.

6. The receiving telecommunications node as set forth in claim 5 wherein each of said supported bits indicates whether said mobile station supports a particular one of said capabilities.

7. The receiving telecommunications node as set forth in claim 6 wherein said information element further comprises at least one support included bit including said valid indication.

8. The receiving telecommunications node as set forth in claim 7 wherein said at least one support included bit indicates whether all of said supported bits are valid.

9. The receiving telecommunications node as set forth in claim 7 wherein said at least one support included bit comprises a respective support included bit for each of said supported bits.

10. The receiving telecommunications node as set forth in claim 1 wherein said receiving telecommunications node is a base station.

11. The receiving telecommunications node as set forth in claim 1 wherein said receiving telecommunications node is a mobile switching center.

12. For use in a wireless network, a sending telecommunications node for sending to a receiving telecommunications node a signal including capabilities of a mobile station served by said receiving telecommunications node, wherein said sending telecommunications node is capable of verifying the validity of said capabilities of said mobile station and including a valid indication in said signal.

13. The sending telecommunications node as set forth in claim 12 wherein said signal comprises an information element including said capabilities.

14. The sending telecommunications node as set forth in claim 13 wherein said information element is an IS-2000 Mobile capabilities information element.

15. The sending telecommunications node as set forth in claim 13 wherein said information element includes a plurality of supported bits containing said capabilities.

16. The sending telecommunications node as set forth in claim 15 wherein each of said supported bits indicates whether said mobile station supports a particular one of said capabilities.

17. The sending telecommunications node as set forth in claim 16 wherein said information element further comprises at least one support included bit including said valid indication.

18. The sending telecommunications node as set forth in claim 17 wherein said at least one support included bit indicates whether all of said supported bits are valid.

19. The sending telecommunications node as set forth in claim 17 wherein said at least one support included bit comprises a respective support included bit for each of said supported bits.

20. The sending telecommunications node as set forth in claim 12 wherein said sending telecommunications node is a base station.

21. The sending telecommunications node as set forth in claim 12 wherein said sending telecommunications node is a mobile switching center.

22. For use in a wireless network, a signal for indicating capabilities of a mobile station within said wireless network, said signal comprising:
at least one supported bit indicating said capabilities; and
at least one support included bit indicating whether said at least one supported bit is valid.

23. The signal as set forth in claim 22 wherein said signal comprises an information element including said capabilities.

24. The signal as set forth in claim 23 wherein said information element is an IS-2000 Mobile Capabilities information element.

25. The signal as set forth in claim 13 wherein said at least one supported bit includes a plurality of supported bits, and wherein each of said supported bits indicates whether said mobile station supports a particular one of said capabilities.

26. The signal as set forth in claim 25 wherein said at least one support included bit indicates whether all of said supported bits are valid.

27. The signal as set forth in claim 25 wherein said at least one support included bit comprises a respective support included bit for each of said supported bits.

28. The signal as set forth in claim 23 wherein said signal comprises a message including said information element.

29. The signal as set forth in claim 28 wherein said message is sent between a base station and a mobile switching center in said wireless network.
